(19) United States
(12) Patent Application Publication
(10) Pub. No.: US 2012/0026203 A1
(43) Pub. Date: Feb. 2, 2012

(54) IMAGE COMPENSATION APPARATUS AND METHOD THEREOF AND FIELD SEQUENTIAL COLOR LIQUID CRYSTAL DISPLAY USING THE SAME

(75) Inventors: Bin-Da Liu, Tainan City (TW); Shih-Tse Wei, Tainan County (TW); Yu-Yun Lee, Tainan City (TW); Ya-Wen Chao, Kaohsiung City (TW); Chao-Hui Wu, Kaohsiung County (TW); Kuan-Hung Lin, Tainan City (TW)

(73) Assignee: HANNSTAR DISPLAY CORPORATION, Taipei County (TW)

(21) Appl. No.: 12/952,211

(22) Filed: Nov. 23, 2010

(30) Foreign Application Priority Data
Jul. 27, 2010 (TW) 99124786

(51) Int. Cl. G09G 5/10

(52) U.S. Cl. 345/690

(57) ABSTRACT

An image compensation apparatus and a method thereof and a field sequential color liquid crystal display (FSC-LCD) using the same are provided. The method includes performing a motion estimation to a first color image information so as to obtain a motion vector; performing a color decomposition to the first color image information so as to obtain a first sub-color-field and a residual color image information; performing a motion compensation to the residual color image information according to the motion vector, so as to obtain a second, a third and a fourth sub-color-fields; and separating a white component from the second, the third and the fourth sub-color-fields into the first sub-color-field, so as to make a color component corresponding to one of the second, the third and the fourth sub-color-fields to be zero, and accordingly output and provide a second color image information to the FSC-LCD to display frame(s).

### CROSS-REFERENCE TO RELATED APPLICATION

This application claims the priority benefit of Taiwan application serial no. 99124786, filed on Jul. 27, 2010. The entirety of the above-mentioned patent application is hereby incorporated by reference herein and made a part of this specification.

### BACKGROUND

1. Field of the Invention

The invention relates to a flat panel display technique, more particularly to, an image compensation apparatus and a method thereof for a field sequential color liquid crystal display.

2. Description of Related Art

With development of photoelectric technology and semiconductor technology, flat panel displays are quickly developed, and in various flat panel displays, a liquid crystal display (LCD) becomes popular in the market due to its advantages of high space utilization rate, low power consumption, no irradiation and low electromagnetic interference, etc. It is known that an LCD includes an LCD panel and a backlight module, and since the LCD panel has no luminescent function itself, the backlight module is required to be disposed under the LCD panel for providing a planar light source to the LCD panel. In this way, the LCD can display images to a user.

In a conventional LCD, a design principle of the backlight module used for providing the planar light source to the LCD panel is to provide a white light, and then the white light is transmitted to color filters on each pixel position within the LCD panel for displaying a color of each pixel. Generally, three color filters, i.e. a red (R) filter, a green (G) filter and a blue (B) filter are required to be disposed on each pixel position to achieve a full color effect. However, such method is not only expensive, but also leads to a low transmittance of each pixel after the white light being processed by the color filters.

Accordingly, in a lately designed LCD, the backlight source of light-emitting diodes (LEDs) is applied for substituting the conventional white light backlight source. Namely, the conventional method of mixing colors of the color filters on a spatial axis, i.e. mixing colors of the red (R), green (G) and blue (B) sub-pixels on the spatial axis within a viewing range of human eyes now may be substituted by mixing colors of the LED backlight source on a time axis. Namely, based on a visual staying principle of the human eyes, images of the three colors red, green and blue are switched swiftly on the time axis, so as to achieve a color mixing effect.

For example, if the images are dynamically displayed for 60 frames per second, and the images of the three colors red, green and blue are switched swiftly on the time axis, a refresh frequency of the images of the three colors red, green and blue is then at least 180 images per second, i.e. an image refresh period is 5.56 ms ( 1/180 second), and this method is the so-called field color sequential method. Accordingly, disposing of the color filters on each pixel position of the LCD panel is unnecessary, and the transmittance of each of the pixels is then improved.

Since the human eyes have the visual staying phenomenon when receiving external images, the LCD driven by the field color sequential method may switch the color images by using a high frequency, so as to cope with the visual staying phenomenon of the human eyes to display full color images. However, since the field sequential color liquid crystal display (FSC-LCD) may probably have a color breakup phenomenon when displaying motion images or static images, a display quality of the FSC-LCD is greatly decreased.

Therefore, to effectively mitigate/resolve the color breakup problem has become one of the major subjects to various manufacturers.

### SUMMARY OF THE INVENTION

Accordingly, the invention is directed to an image compensation apparatus and a method thereof for a field sequential color liquid crystal display (FSC-LCD), which can effectively mitigate/resolve a color breakup phenomenon occurred when the FSC-LCD displays motion/static images.

The invention provides an image compensation apparatus of an FSC-LCD, which includes a motion estimation unit, a decomposition unit, a motion compensation unit and an adjustment unit. Wherein, the motion estimation unit receives a first color image information, and performs a motion estimation to the first color image information to obtain a motion vector. The decomposition unit receives the first color image information, and performs a color decomposition to the first color image information to obtain a first sub-color-field and a residual color image information.

The motion compensation unit is coupled to the motion estimation unit and the decomposition unit, and is used for receiving the residual color image information and the motion vector, and performing a motion compensation to the residual color image information according to the motion vector, so as to obtain a second, a third and a fourth sub-color-fields. The adjustment unit is coupled to the decomposition unit and the motion compensation unit, and is used for receiving the first to the fourth sub-color-fields, and separating a white component from the second, the third and the fourth sub-color-fields into the first sub-color-field, so as to make a color component corresponding to one of the second, the third and the fourth sub-color-fields to be zero, and accordingly output and provide a second color image information to the FSC-LCD to display a frame.

The invention provides an image compensation method of an FSC-LCD. The method can be described as follows. A motion estimation is performed to a first color image information, so as to obtain a motion vector. A color decomposition is performed to the first color image information, so as to obtain a first sub-color-field and a residual color image information. A motion compensation is performed to the residual color image information according to the motion vector, so as to obtain a second, a third and a fourth sub-color-fields. A white component is separated from the second, the third and the fourth sub-color-fields into the first sub-color-field, so as to make a color component corresponding to one of the second, the third and the fourth sub-color-fields to be zero, and accordingly output a second color image information to the FSC-LCD to display a frame.

The invention further provides an FSC-LCD, which includes the aforementioned image compensation apparatus and a display module. Wherein, the display module displays frames in response to a second color image information output by the image compensation apparatus.

According to the above descriptions, based on processing of the first color image information performed by the image compensation apparatus of the invention, regardless whether the frames displayed by the display module of the FSC-LCD in response to the second color image information are motion frames or static frames, the color breakup phenomenon is avoided. In this way, the display quality of the FSC-LCD can be greatly improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a field sequential color liquid crystal display (FSC-LCD) according to an embodiment of the invention.

FIG. 2 is a block diagram illustrating an image compensation apparatus according to an embodiment of the invention.

FIG. 3 is a schematic diagram illustrating a red (R), a green (G) and a blue (B) image information of a pixel according to an embodiment of the invention.

FIGS. 4A-4E, FIG. 5 and FIGS. 6A-6D are explanation schematic diagrams of an FSC-LCD according to an embodiment of the invention.

FIG. 7 is a block diagram illustrating a display module according to an embodiment of the invention.

FIG. 8 is a flowchart illustrating an image compensation method of an FSC-LCD according to an embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

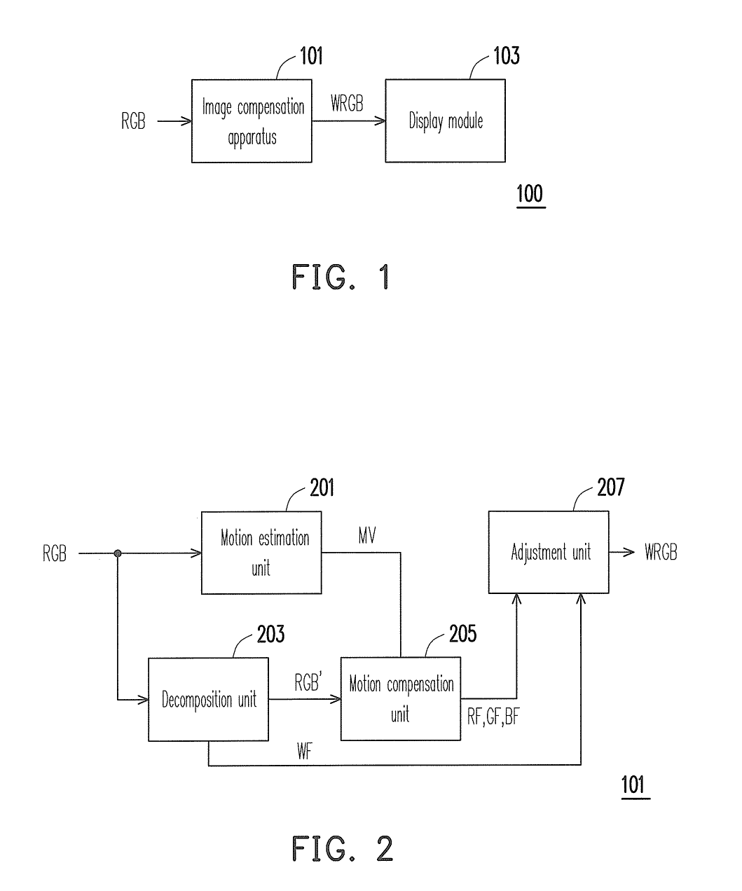

FIG. 1 is a block diagram illustrating a field sequential color liquid crystal display (FSC-LCD) 100 according to an embodiment of the invention. Referring to FIG. 1, the FSC-LCD 100 includes an image compensation apparatus 101 and a display module 103. Wherein, the image compensation apparatus 10 is used for processing an inputted color image information RGB, so as to output a color image information WRGB to the display module 103 for displaying a motion/static frame. Here, the color image information RGB may include a red (R), a green (G) and a blue (B) color image information, though the invention is not limited thereto. The color image information WRGB may include a white (W), a red (R), a green (G) and a blue (B) color image information, though the invention is not limited thereto.

In the present embodiment, based on the processing of the color image information RGB performed by the image compensation apparatus 101, regardless whether the frames displayed by the display module 103 in response to the color image information WRGB are motion frames or static frames, the color breakup phenomenon is avoided. In this way, the display quality of the FSC-LCD 100 can be greatly improved, so that the problem of the conventional technique can be effectively mitigated/resolved.

In detail, FIG. 2 is a block diagram illustrating the image compensation apparatus 101 according to an embodiment of the invention. Referring to FIG. 2, the image compensation apparatus 101 includes a motion estimation unit 201, a decomposition unit 203, a motion compensation unit 205 and an adjustment unit 207. The motion estimation unit 201 receives the color image information RGB, and performs a motion estimation to the color image information RGB to obtain a motion vector MV.

The decomposition unit 203 receives the color image information RGB, and performs a color decomposition to the color image information RGB to obtain a first sub-color-field (for example, a white sub-color-field) WF and a residual color image information RGB′. In the present embodiment, the first sub-color-field WF relates to a white component in the color image information RGB, and the residual color image information RGB′ relates to color components other than the white component in the color mage information RGB.

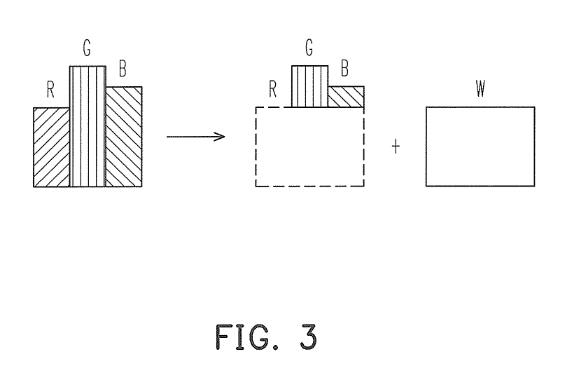

Taking the color image information RGB of a single pixel as an example, and assuming a relationship of a red (R), a green (G) and a blue (B) color image information of the pixel are as that shown in FIG. 3, i.e. a red pixel value is the minimum, a blue pixel value is the secondary, and a green pixel value is the maximum. In this way, the white component in the color image information RGB is W, and the color components other than the white component W in the color image information RGB are the green (G) and the blue (B) color image information.

The motion compensation unit 205 is coupled to the motion estimation unit 201 and the decomposition unit 203. The motion compensation unit 205 receives the residual color image information RGB′ and the motion vector MV, and performs a motion compensation to the residual color image information RGB′ according to the motion vector MV (the motion compensation is not directly performed to the original inputted color image information RGB), so as to obtain a second sub-color-field (for example, a red sub-color-field) RF, a third sub-color-field (for example, a green sub-color-field) GF and a fourth sub-color-field (for example, a blue sub-color-field) BF.

The adjustment unit 207 is coupled to the decomposition unit 203 and the motion compensation unit 205. The adjustment unit 207 receives the first to the fourth sub-color-fields WF, RF, GF and BF, and separates a white component from the second, the third and the fourth sub-color-fields RF, GF and BF into the first sub-color-field WF, so as to make a color component corresponding to one of the second to the fourth sub-color-fields RF, GF and BF to be zero, and accordingly output the color image information WRGB to the display module 103 for displaying a motion/static frame.

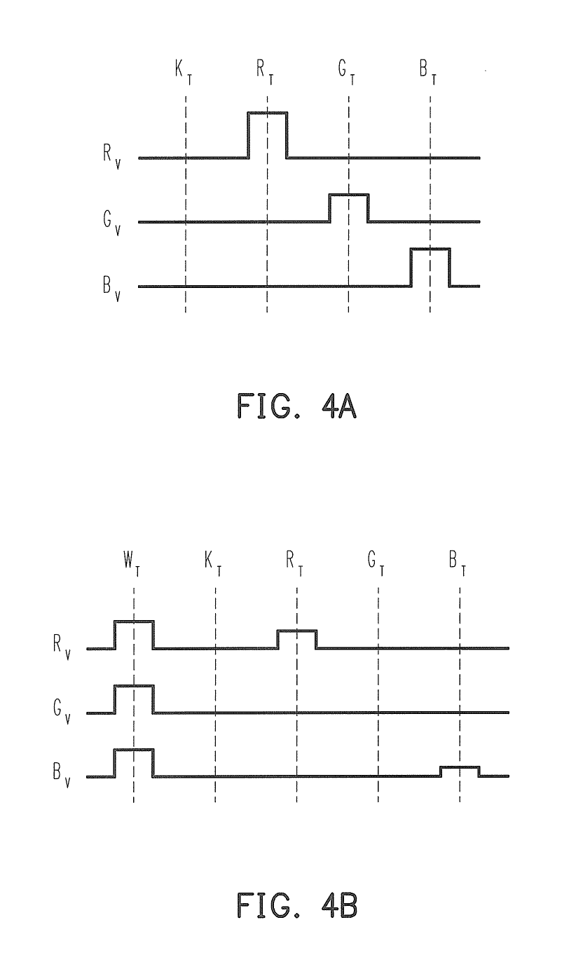

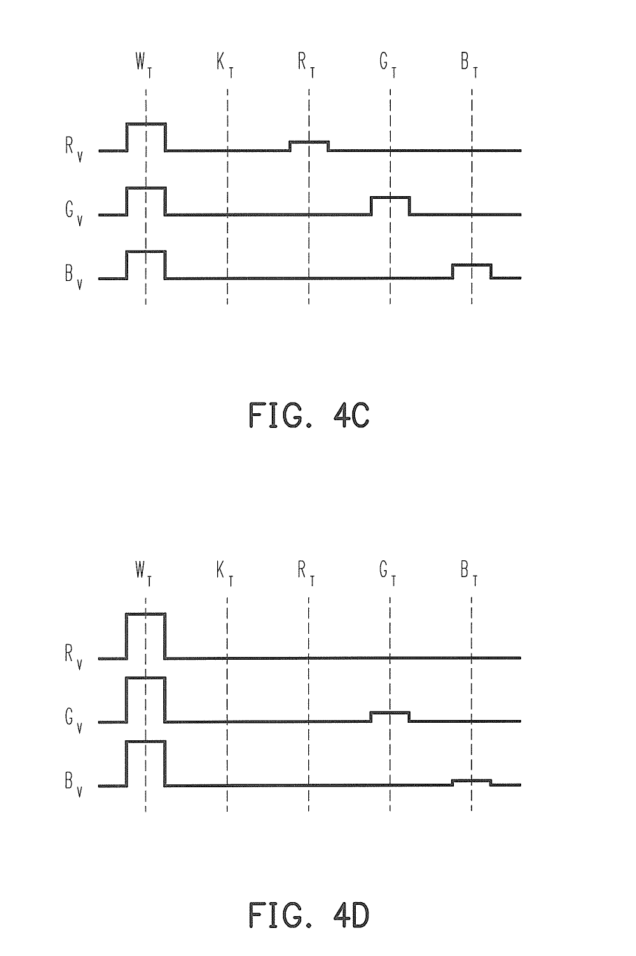

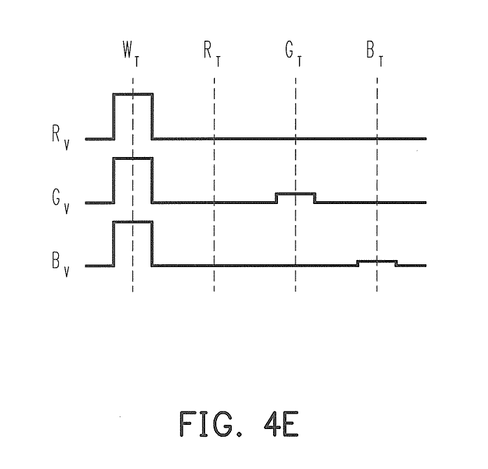

According to the above descriptions, during a process that the optically compensated bend (OCB) FSC-LCD 100 sequentially lights up a red backlight source R_{T}, a green backlight source G_{T} and a blue backlight source B_{T} (as that shown in FIG. 4A), a period of time K_{T} has to be maintained to display a fully black frame (i.e. the red, the green and the blue backlight sources are all turned off), which is equivalent to insert a single-color (i.e. black) field frame. Then, a red field frame, a green field frame and a blue field frame are sequentially displayed. Wherein, Rv, Gv and By shown in FIG. 4A can be regarded as a color image information RGB of a single pixel. Therefore, a situation that the green pixel value is the minimum, the blue pixel value is the secondary and the red pixel value is the maximum is taken as an example for description.

In this way, the decomposition unit 203 is used to perform the color decomposition to the color image information RGB, so that the FSC-LCD 100 is changed to sequentially lights up a white backlight source W_{T} (i.e. the red, the green and the blue backlight sources are all turned on), a black backlight source K_{T} (i.e. the red, the green and the blue backlight sources are all turned off), the red backlight source R_{T}, the green backlight source G_{T} and the blue backlight source B_{T} (as that shown in FIG. 4B). Therefore, the FSC-LCD 100 sequentially displays a white field frame, the black field frame, the red field frame, the green field frame and the blue field frame. According to FIG. 4B, the color components other than the white component in the color image information RGB are only the red and the blue color image information, i.e. the residual color image information RGB′.

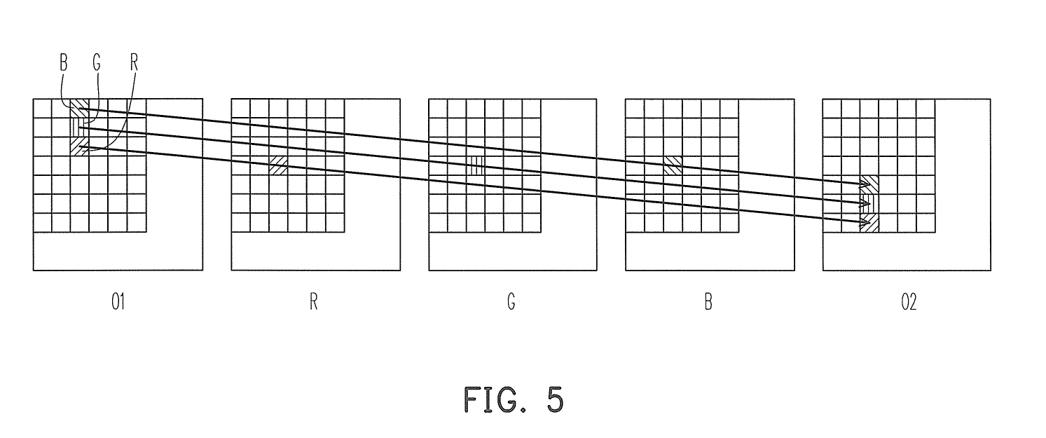

Then, when the motion compensation unit 205 performs the motion compensation to the residual color image information RGB′ in a RGB domain according to the motion vector MV, since obtained positions are generally not on the same pixel points, i.e. as that shown in FIG. 5, positions of sub pixels R, G and B are not on the same positions in two adjacent frames O1 and O2, the second to the fourth sub-color-fields RF, GF and BF (i.e. the red, the green and the blue sub-color-fields) obtained after the motion compensation unit 205 performs the motion compensation to the residual color image information RGB′ in the RGB domain according to the motion vector MV may all have values (as that shown in FIG. 4C), and now the red pixel value is the minimum, the blue pixel value is the secondary, and the green pixel value is the maximum.

Accordingly, the adjustment unit 207 has to be used to separate the white component from the second to the fourth sub-color-fields RF, GF and BF (i.e. the red, the green and the blue sub-color-fields) into the first sub-color-field WF (i.e. the white sub-color-field), so as to make a color component corresponding to one of the second to the fourth sub-color-fields RF, GF and BF to be zero, i.e. the color component corresponding to the second sub-color-field RF is zero (as that shown in FIG. 4D).

In the present embodiment, since the second to the fourth sub-color-fields RF, GF and BF (i.e. the red, the green and the blue sub-color-fields) obtained after the motion compensation unit 205 performs the motion compensation to the residual color image information RGB′ in the RGB domain according to the motion vector MV, and the first sub-color-field WF (i.e. the white sub-color-field) obtained after the decomposition unit 203 performs the color decomposition to the color image information RGB are again adjusted (i.e. color decomposition) by the adjustment unit 207, one of the red (R), the green (G) and the blue (B) color image information in the color image information RGB of the pixel is zero.

Therefore, the feature of inserting a fully black field frame to the OCB FSC-LCD 100 can be satisfied by one of the red (R), the green (G) and the blue (B) color image information in the color image information WRGB (since one of the red (R), the green (G) and the blue (B) color image information is zero). In this way, the FSC-LCD 100 of the present embodiment is unnecessary to add a display time for the black field frame (as that shown in FIG. 4E), so that the adjustment unit 207 is only required to output the color image information WRGB having the white (W), the red (R), the green (G) and the blue (B) color image information to the display module 103, and thus the display module 103 can display the motion/static frame without the color breakup phenomenon.

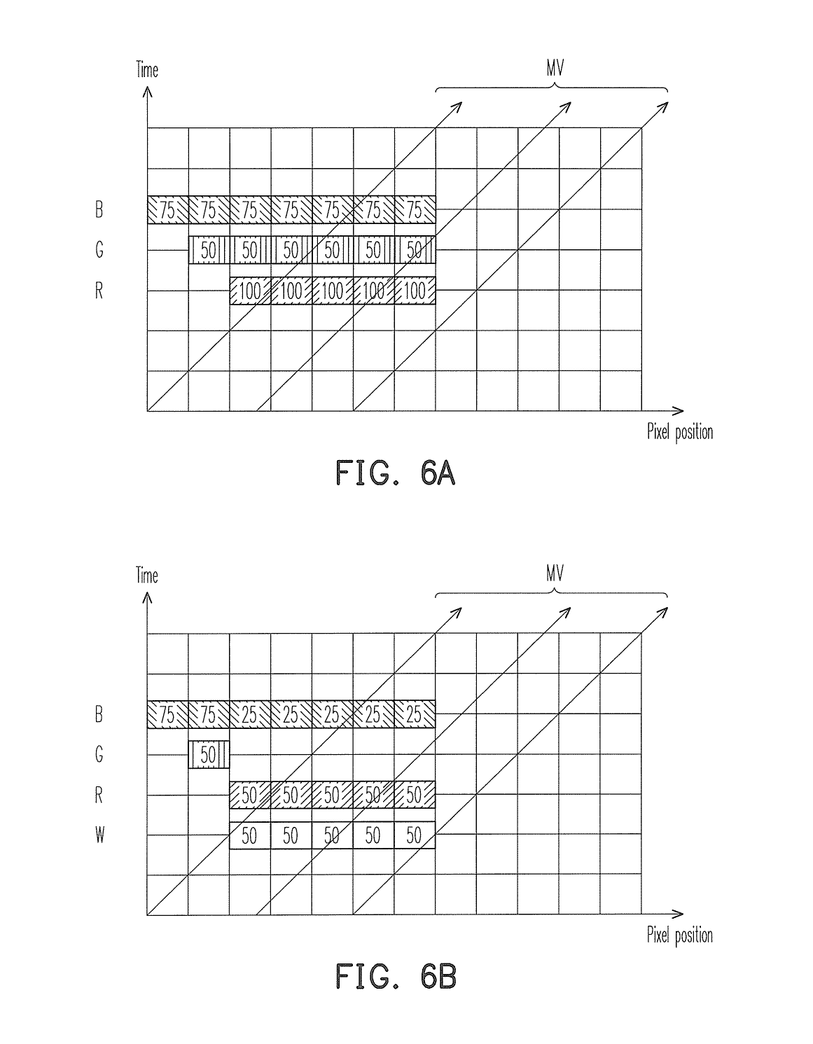

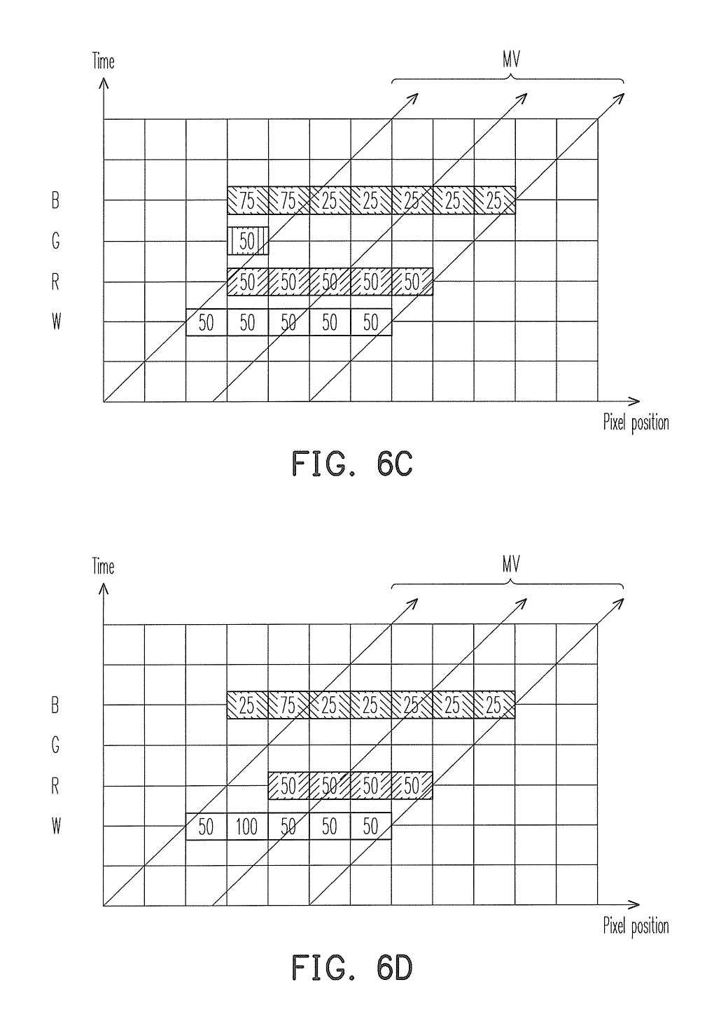

According to another aspect, referring to FIGS. 6A-6D, in which a horizontal axis represents pixel positions, a vertical axis represents time, and diagonal arrows represent the motion vector MV. According to FIG. 6A, it is known that the green pixel value is 50, the blue pixel value is 75 and the red pixel value is 100. Wherein, the three color pixel values relate to the red (R), the green (G) and the blue (B) color image information in the color image information RGB of the pixel, i.e. the red (R), the green (G) and the blue (B) color image information in the original inputted color image information RGB.

Moreover, according to FIG. 6B, it is known that in case of the same pixel positions, according to a result that the decomposition unit 203 performs the color decomposition to the color image information RGB, the first sub-color-field WF related to the white component W of the color image information RGB is obtained, and the residual color image information RGB′ related to the color components other than the white component W in the color image information RGB is obtained. In this way, the pixel value corresponding to the white component W in the color image information RGB is 50, the pixel values corresponding to the red (R) and the blue (B) color image information of the same pixel positions are respectively 50 and 25 (i.e. the residual color image information RGB′), and the pixel values corresponding to the green (G) and the blue (B) color image information of different pixel positions are respectively 50 and 75.

Moreover, since the motion compensation unit 205 may perform the motion compensation to the residual color image information RGB′ according to the motion vector MV, an object traced by human eyes is moved rightwards. Now, according to FIG. 6C, it is known that the second to the fourth sub-color-fields RF, GF and BF (i.e. the red, the green and the blue sub-color-fields) obtained after the motion compensation unit 205 performs the motion compensation to the residual color image information RGB′ in the RGB domain according to the motion vector MV may all have values (since the obtained positions are not on the same pixel points). Therefore, in case of the same pixel positions, the second to the fourth sub-color-fields RF, GF and BF may still have the white component W, and the corresponding pixel values thereof are 50.

Therefore, according to FIG. 6D, after the adjustment unit 207 separates the white component W from the second to the fourth sub-color-fields RF, GF and BF (i.e. the red, the green and the blue sub-color-fields) into the first sub-color-field WF (i.e. the white sub-color-field), not only the pixel value of the white component W corresponding to the red (R), the green (G) and the blue (B) color image information of the same pixel positions is changed to 100, but also the pixel value corresponding to the blue (B) color image information of the same pixel position is also changed to 25, and thus the color component corresponding to one of the second to the fourth sub-color-fields RF, GF and BF is changed to zero (i.e. the color component corresponding to the third sub-color-field GF is zero).

Therefore, the feature of inserting a fully black field frame to the OCB FSC-LCD 100 can be satisfied by one of the red (R), the green (G) and the blue (B) color image information in the color image information WRGB (since one of the red (R), the green (G) and the blue (B) color image information is zero). In this way, the FSC-LCD 100 of the present embodiment is unnecessary to add a display time for the black field frame, so that the adjustment unit 207 is only required to output the color image information WRGB having the white (W), the red (R), the green (G) and the blue (B) color image information to the display module 103, and the display module 103 can display the motion/static frame without the color breakup phenomenon.

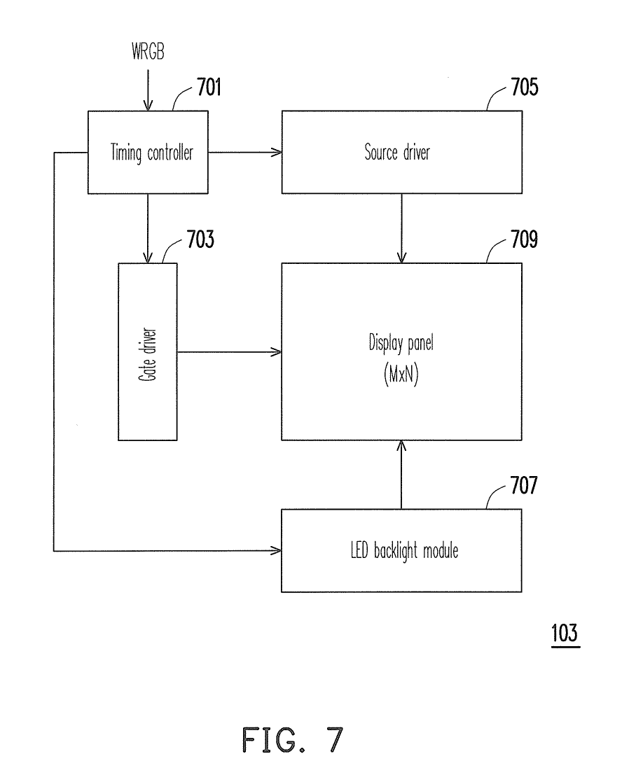

In the present embodiment, once the adjustment unit 207 outputs the color image information WRGB having the white (W), the red (R), the green (G) and the blue (B) color image information to the display module 103, the display module 103 may accordingly display the motion/static frame without the color breakup phenomenon. In detail, FIG. 7 is a block diagram illustrating the display module 103 according to an embodiment of the invention. Referring to FIG. 7, the display module 103 includes a timing controller (T-con) 701, a gate driver 703, a source driver 705, a light emitting diode (LED) backlight module 707 and a display panel 709 with a resolution of M*N (wherein M and N are positive integers), though the invention is not limited thereto.

In the present embodiment, when the timing controller 701 receives the color image information WRGB output by the adjustment unit 207, the timing controller 701 may generate some related operation signals for controlling operations of the gate driver 703, the source driver 705 and the LED backlight module 707, so that the gate driver 703 and the source driver 705 may generate scan signals and data signals to drive the display panel 709, and the LED backlight module 707 may sequentially provide backlight sources of corresponding colors (i.e. white, red, green and blue).

In this way, the display module 103 may display the motion/static frame without the color breakup phenomenon in response to the color image information WRGB output by the adjustment unit 207. However, since a method that the timing controller 701 controls the operations of the gate driver 703, the source driver 705 and the LED backlight module 707 is known by those skilled in the art, detailed descriptions thereof are not repeated.

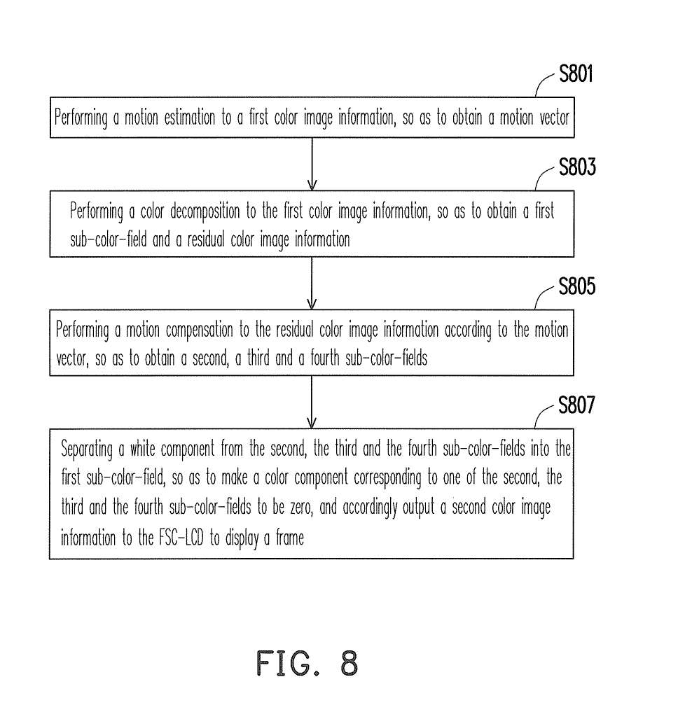

FIG. 8 is a flowchart illustrating an image compensation method of an FSC-LCD according to an embodiment of the invention. Referring to FIG. 8, the image compensation method of the FSC-LCD may include following steps, and a sequence of the following steps can be suitably adjusted according to an actual requirement.

A motion estimation is performed to a first color image information (which may include a red (R), a green (G) and a blue (B) color image information, though the invention is not limited thereto), so as to obtain a motion vector (step S801).

A color decomposition is performed to the first color image information, so as to obtain a first sub-color-field (for example, a white sub-color-field, which relates to a white component of the first color image information) and a residual color image information (which relates to color components other than the white component in the first color image information) (step S803).

A motion compensation is performed to the residual color image information according to the motion vector, so as to obtain a second, a third and a fourth sub-color-fields (which are, for example, a red, a green and a blue sub-color-field) (step S805).

A white component is separated from the second, the third and the fourth sub-color-fields into the first sub-color-field, so as to make a color component corresponding to one of the second, the third and the fourth sub-color-fields to be zero, and accordingly output a second color image information (which may include a white (W), a red (R), a green (G) and a blue (B) color image information, though the invention is not limited thereto) to the FSC-LCD to display a frame (step S807).

In summary, based on processing of the first color image information performed by the image compensation apparatus of the invention, regardless whether the frames displayed by the display module of the FSC-LCD in response to the second color image information are motion frames or static frames, the color breakup phenomenon is avoided. In this way, the display quality of the FSC-LCD can be greatly improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image compensation apparatus of a field sequential color liquid crystal display (FSC-LCD), comprising:
a motion estimation unit, for receiving a first color image information, and performing a motion estimation to the first color image information to obtain a motion vector;
a decomposition unit, for receiving the first color image information, and performing a color decomposition to the first color image information to obtain a first sub-color-field and a residual color image information;
a motion compensation unit, coupled to the motion estimation unit and the decomposition unit, for receiving the residual color image information and the motion vector, and performing a motion compensation to the residual color image information according to the motion vector, so as to obtain a second, a third and a fourth sub-color-fields; and
an adjustment unit, coupled to the decomposition unit and the motion compensation unit, for receiving the first to the fourth sub-color-fields, and separating a white component from the second, the third and the fourth sub-color-fields into the first sub-color-field, so as to make a color component corresponding to one of the second, the third and the fourth sub-color-fields to be zero, and accordingly output a second color image information to the FSC-LCD to display a frame.

2. The image compensation apparatus of the FSC-LCD as claimed in claim 1, wherein the first sub-color-field relates to a white component of the first color image information, and the residual color image information relates to color components other than the white component in the first color image information.

3. The image compensation apparatus of the FSC-LCD as claimed in claim 1, wherein the first color image information comprises a red (R), a green (G) and a blue (B) color image information, and the second color image information comprises a white (W), a red (R), a green (G) and a blue (B) color image information.

4. The image compensation apparatus of the FSC-LCD as claimed in claim 1, wherein the first to the fourth sub-color-fields are respectively a white (W), a red (R), a green (G) and a blue (B) sub-color-fields.

5. An image compensation method of a field sequential color liquid crystal display (FSC-LCD), comprising:
performing a motion estimation to a first color image information, so as to obtain a motion vector;
performing a color decomposition to the first color image information, so as to obtain a first sub-color-field and a residual color image information;
performing a motion compensation to the residual color image information according to the motion vector, so as to obtain a second, a third and a fourth sub-color-fields; and
separating a white component from the second, the third and the fourth sub-color-fields into the first sub-color-field, so as to make a color component corresponding to one of the second, the third and the fourth sub-color-fields to be zero, and accordingly output a second color image information to the FSC-LCD to display a frame.

6. The image compensation method of the FSC-LCD as claimed in claim 5, wherein the first sub-color-field relates to a white component of the first color image information, and the residual color image information relates to color components other than the white component in the first color image information.

7. The image compensation method of the FSC-LCD as claimed in claim 5, wherein the first color image information comprises a red (R), a green (G) and a blue (B) color image information, and the second color image information comprises a white (W), a red (R), a green (G) and a blue (B) color image information.

8. The image compensation method of the FSC-LCD as claimed in claim 5, wherein the first to the fourth sub-color-fields are respectively a white (W), a red (R), a green (G) and a blue (B) sub-color-fields.

9. A field sequential color liquid crystal display (FSC-LCD), comprising:
a display module; and
an image compensation apparatus, coupled to the display module, comprising:
a motion estimation unit, for receiving a first color image information, and performing a motion estimation to the first color image information to obtain a motion vector;
a decomposition unit, for receiving the first color image information, and performing a color decomposition to the first color image information to obtain a first sub-color-field and a residual color image information.
a motion compensation unit, coupled to the motion estimation unit and the decomposition unit, for receiving the residual color image information and the motion vector, and performing a motion compensation to the residual color image information according to the motion vector, so as to obtain a second, a third and a fourth sub-color-fields; and
an adjustment unit, coupled to the decomposition unit and the motion compensation unit, for receiving the first to the fourth sub-color-fields, and separating a white component from the second, the third and the fourth sub-color-fields into the first sub-color-field, so as to make a color component corresponding to one of the second, the third and the fourth sub-color-fields to be zero, and accordingly output a second color image information to the display module to display a frame.

10. The FSC-LCD as claimed in claim 9, wherein the first sub-color-field relates to a white component of the first color image information, and the residual color image information relates to color components other than the white component in the first color image information.

11. The FSC-LCD as claimed in claim 9, wherein the first color image information comprises a red (R), a green (G) and a blue (B) color image information, and the second color image information comprises a white (W), a red (R), a green (G) and a blue (B) color image information.

12. The FSC-LCD as claimed in claim 9, wherein the first to the fourth sub-color-fields are respectively a white (W), a red (R), a green (G) and a blue (B) sub-color-fields.
